(19) United States
(12) Patent Application Publication
(10) Pub. No.: US 2020/0024400 A1
(43) Pub. Date: Jan. 23, 2020

(54) METHODS OF MANUFACTURE FOR POLYETHERIMIDE

(71) Applicant: SABIC GLOBAL TECHNOLOGIES B.V., BERGEN OP ZOOM (NL)

(72) Inventors: DADASAHEB V. PATIL, EVANSVILLE, IN (US); PETER L. JOHNSON, EVANSVILLE, IN (US)

(21) Appl. No.: 16/469,306

(22) PCT Filed: Dec. 28, 2017
(86) PCT No.: PCT/US2017/068704

§ 371 Date: Jun. 13, 2019

Related U.S. Application Data
(60) Provisional application No. 62/441,253, filed on Dec. 31, 2016.

(51) Int. Cl. C08G 73/10

(52) U.S. Cl. CPC C08G 73/1071; C08G 73/1021; C08G 73/1032; C08G 73/1014

(57) ABSTRACT

A method of making a polyetherimide comprising reacting a diamine having four bonds or more between the amine groups, 3,3′-bisphenol A dianhydride, and 4,4′-bisphenol A dianhydride to form a polyetherimide having a cyclics content less than 1 weight percent (wt %), a glass transition temperature greater than or equal to 213° C., and a weight average molecular weight greater than or equal to 25,000 Daltons, wherein the molar ratio of 3,3′-bisphenol A dianhydride to 4,4′-bisphenol A dianhydride is 98:02 to 10:90.

### BACKGROUND

Polyetherimides (“PEIs”) are amorphous, transparent, high performance polymers having a glass transition temperature (“Tg”) typically greater than 180° C. PEIs further have high strength, heat resistance, and broad chemical resistance, and are widely used in applications as diverse as automotive, telecommunication, aerospace, electrical/electronics, transportation, and healthcare.

However, the high viscosity of polyetherimide prevents its use in some applications requiring complex molds to be filled, especially molds with thin wall sections. Therefore there is a need for a polyetherimide with sufficiently low viscosity to fill complex molds. The viscosity requirement is coupled with a need for ductility and thermal stability to allow manipulation of the molded article.

There accordingly remains a need in the art for methods for the manufacture of polyetherimides having improved properties, in particular polyetherimides having high Tg and improved flow at high shear, but with reduced levels of undesirable byproducts, including halogenated byproducts and low molecular weight cyclic byproducts. Such byproducts can have detrimental effect on the properties of resultant polymer. Such detrimental effects include lower glass transition temperature, reduced ductility, and reduced glossiness.

### BRIEF DESCRIPTION

A method of making a polyetherimide comprises reacting a diamine having four bonds or more between the amine groups, 3,3′-bisphenol A dianhydride, and 4,4′-bisphenol A dianhydride to form a polyetherimide having a cyclics content less than 1 weight percent (wt %), a glass transition temperature greater than or equal to 213° C., and a weight average molecular weight greater than or equal to 25,000 Daltons, wherein the molar ratio of 3,3′-bisphenol A dianhydride to 4,4′-bisphenol A dianhydride is 98:02 to 10:90. The produced polyetherimide has a viscosity that is at least 25% lower than the viscosity of a polyetherimide produced using 100 mol % 4,4′-bisphenol A dianhydride.

In some embodiments, a method of making a polyetherimide comprises reacting a diamine having 4 to 10 bonds between the amine groups, 3,3′-bisphenol A dianhydride, and 4,4′-bisphenol A dianhydride to form a polyetherimide having a cyclics content less than 1 wt % based on the total weight of the polyetherimide, a glass transition temperature greater than or equal to 213° C., and a weight average molecular weight greater than or equal to 25,000 Daltons, wherein the molar ratio of 3,3′-bisphenol A dianhydride to 4,4′-bisphenol A dianhydride is 98:02 to 10:90. The produced polyetherimide has a viscosity that is at least 25% lower than the viscosity of a polyetherimide produced using 100 mol % 4,4′-bisphenol A dianhydride.

In some embodiments, a method of making a polyetherimide comprises reacting metaphenylenediamine or 4,4′-diaminodiphenyl ether, 3,3′-bisphenol A dianhydride, 4,4′-bisphenol A dianhydride and phthalic anhydride in a solvent to form a polyetherimide having a cyclics content less than 1 wt % based on the total weight of the polyetherimide, a glass transition temperature greater than or equal to 213° C., and a weight average molecular weight greater than or equal to 25,000 Daltons, wherein the molar ratio of 3,3′-bisphenol A dianhydride to 4,4′-bisphenol A dianhydride is 98:02 to 10:90. The produced polyetherimide has a viscosity that is at least 25% lower than the viscosity of a polyetherimide produced using 100 mol % 4,4′-bisphenol A dianhydride.

The above described and other features are exemplified by the following figures and detailed description.

### BRIEF DESCRIPTION OF THE FIGURES

FIG. 1 is a graphical representation of data from the Examples.

### DETAILED DESCRIPTION

Described herein is a method of making a polyetherimide having an extremely low level of cyclic byproduct. This results in a polyetherimide with a high glass transition temperature (typically greater than 215° C.), low viscosity and excellent ductility. Making a polyetherimide using the ether-forming polymerization process (sometimes referred to as the halo-displacement polymerization process) is known to lead to cyclic byproduct content as high as 15 weight percent, based on the total weight of the polyetherimide. As mentioned above the cyclic byproduct can have detrimental effects on the polyetherimide properties. Surprisingly, using the polycondensation method described herein leads to unexpectedly low levels of cyclic byproduct despite having the same structural units.

Polyetherimides comprise more than 1, for example 2 to 1000, or 5 to 500, or 10 to 100 structural units of formula (1)

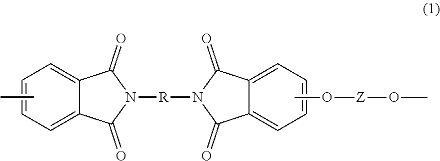

wherein each R is independently the same or different, and is a substituted or unsubstituted divalent organic group, such as a substituted or unsubstituted C₆₋₂₀ aromatic hydrocarbon group, a substituted or unsubstituted straight or branched chain C₄₋₂₀ alkylene group, a substituted or unsubstituted C₄₋₂₀ cycloalkylene group. Suitable aromatic moieties include, but not limited to, monocyclic, polycyclic and fused aromatic compounds having 6 to 20, or, more specifically, 6 to 18 ring carbon atoms, and their substituted derivatives. Polycyclic aromatic moieties may be directly linked (such as, for example biphenyl) or may be separated by 1 or 2 atoms comprising linking moieties. Illustrative non-limiting examples of aromatic moieties include phenyl, biphenyl, naphthyl, and phenanthryl, and their substituted derivatives. At least a portion of the R groups are chosen so that there are 4 or more bonds between the nitrogen atoms. The number of bonds between the nitrogens (and hence the number of bonds between the amino groups) is defined as the least number of consecutive bonds between the nitrogen atoms. In some embodiments the majority of the R groups are chosen so that there are 4 bonds between the nitrogen atoms. The amount of R groups having 4 or more bonds between the nitrogen atoms may be greater than or equal to 50 mol %, or, greater than or equal to 75 mol %, or, greater than or equal to 95 mol %, based on the total number of moles of diamine.

Further in formula (1), the divalent bonds of the —O—Z—O— group are in the 3,3′, or the 4,4′ positions, and Z is a divalent group of formula (2)

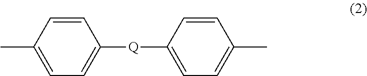

derived from bisphenol A, such that Q in formula (2) is 2,2-isopropylidene. In some embodiments in formula (1), R is m-phenylene.

The polyetherimide is the reaction product of an aromatic bis(ether anhydride) of formula (3) or a chemical equivalent thereof, with an organic diamine of formula (4)

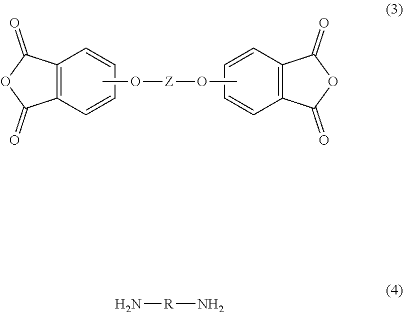

wherein Z and R are defined as described above.

Examples of organic diamines having 4 or more bonds between the nitrogen atoms include propylenediamine, trimethylenediamine, 2,2-dimethylpropylenediamine, 1,2-diaminocyclohexanediamine, 1,3-cyclohexanediamine, m-phenylenediamine, 2,4-diaminotoluene, 2,6-diaminotoluene, 2-methyl-4,6-diethyl-1,3-phenylene-diamine, 5-methyl-4,6-diethyl-1,3-phenylene-diamine, 1,8-diaminonaphthalene, 1,2-diaminonaphthalene, 1,3-diaminonaphthalene, 1,3-diamino-4-isopropylbenzene, 9H-fluorene-1,9-diamine, phenazine-1,3-diamine, 2,5-furandiamine, 2,4-diaminopyridine, 2,6-diaminpyridine, 4,6-diaminopyrimidine, 2,5-thiophenediamine, and 3,4-thiophenediamine 1,1-dioxide. Illustrative examples of amine compounds of formula (4) having five or more bonds between amino groups include 1,4-butanediamine, 1,5-pentanediamine, 1,6-hexanediamine, methylated and polymethylated derivatives of the foregoing, heptamethylenediamine, octamethylenediamine, nonamethylenediamine, decamethylenediamine, 1,11-diaminoundecane, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, bis(aminocyclohexyl)isopropylidene, di(aminomethyl)cyclohexane, bis(aminomethyl)cyclohexanes, diaminobicycloheptane, diaminomethylbicycloheptane, diaminooxybicycloheptane, isophoronediamine, diaminotricyclodecane, 6,6′-bis(3-aminophenoxy)-3,3,3′,3′-tetramethyl-1,1′-spirobiindane, 6,6′-bis(4-aminophenoxy)-3,3,3′,3′-tetramethyl-1,1′-spirobiindane, diaminomethyltricyclodecane, siloxane diamines, such as 1,3-bis(3-aminopropyl)tetramethyldisiloxane, 1,3-bis(4-aminobutyl)tetramethyldisiloxane, α,ω-bis(3-aminopropyl)polydimethylsiloxane, and α,ω-bis(3-aminobutyl)polydimethylsiloxane, 3 3′-diamino-4,4′-diphenoxybenzophenone, 3,3′-diamino-4-biphenoxybenzophenone, 3,3′-diaminobenzophenone, 4,4′-diaminobenzophenone, 4,4′-bis(3-aminophenoxy)biphenyl, bis[4-(3-aminophenoxy)phenyl]ketone, 1,3-bis[4-(3-aminophenoxy)benzoyl]benzene, 4′-bis[4-(4-aminophenoxy)benzoyl]diphenylether, 1,3-bis(3-aminophenoxy)benzene, 1,4-bis(4-aminophenoxy)benzene, 2,2-di(4-aminophenyl)-1,1,1,3,3,3-hexafluoropropane, bis(aminomethyl)ether, bis(2-aminoethyl)ether, bis(3-aminopropyl)ether, p-phenylenediamine, m-xylylenediamine, p-xylylenediamine, benzidine, 3,3′-dimethylbenzidine, 3,3′-dimethoxybenzidine, 1,4-diaminonaphthalene, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1,3-diamino-4-isopropylbenzene, bis(4-aminophenyl) sulfide, bis-(4-aminophenyl) sulfone (also known as 4,4′-diaminodiphenyl sulfone (DDS)), and bis(4-aminophenyl) ether (4,4′ oxydianiline). Regioisomers of these diamines can be employed. Combinations of these amines can be used.

In a specific embodiment diamine (4) is a meta-phenylene diamine (5)

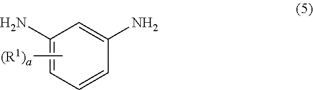

wherein R¹ is independently a halogen atom, nitro, cyano, C₂-C₂₀ aliphatic group, C₂-C₄₀ aromatic group, and a is independently 0 to 4. Specific examples include meta-phenylenediamine (mPD), 2,4-diaminotoluene, 2,6-diaminotoluene, 2-methyl-4,6-diethyl-1,3-phenylenediamine, 5-methyl-4,6-diethyl-1,3-phenylenediamine, or 1,3-diamino-4-isopropylbenzene. Combinations comprising any of the foregoing amines can be used.

The polyetherimides can have a glass transition temperature of greater than or equal to 213° C., specifically of 213° C. to 240° C., as measured using differential calorimetry (DSC) per ASTM test D3418.

The produced polyetherimide has a viscosity that is at least 25% lower, or, at least 30% lower, or, at least 40% lower than the viscosity of a polyetherimide produced using 100 mol % 4,4′-bisphenol A dianhydride. Viscosity is determined using parallel plate rheometry at 380° C.

The polyetherimides can have a melt index of 0.1 to 10 grams per minute (g/min), as measured by American Society for Testing Materials (ASTM) D1238 at 340 to 370° C., using a 6.7 kilogram (kg) weight. In some embodiments, the polyetherimide has a weight average molecular weight (Mw) of 25,000 to 150,000 grams/mole (Dalton), as measured by gel permeation chromatography, using polystyrene standards. In some embodiments the polyetherimide has an Mw of 10,000 to 80,000 Daltons. Such polyetherimides typically have an intrinsic viscosity greater than 0.2 deciliters per gram (dl/g), or, more specifically, 0.35 to 0.7 dl/g as measured in m-cresol at 25° C.

The polycondensation reaction can be conducted under either melt polymerization conditions or solution polymerization conditions.

In instances where melt polymerization is employed, the reaction is conducted in the absence of any organic solvent. Melt polymerization can be achieved in a melt extruder, as taught for example, by Mellinger et al. in U.S. Pat. No. 4,073,773.

In instances wherein solution polymerization is practiced, there can be utilized various organic solvents, for example relatively non-polar solvents, specifically with a boiling point above about 100° C., and more specifically above about 150° C., for example o-dichlorobenzene, dichlorotoluene, 1,2,4-trichlorobenzene, diphenyl sulfone, a monoalkoxybenzene such as anisole, veratrole, diphenylether, or phenetole, sulfolane, dimethyl sulfone, dimethyl formamide, dimethyl acetamide, N-methylpyrrolidone, dimethyl sulfoxide, m-cresol, hexamethyl phosphoramide, dimethyl imidazole, or a combination thereof. Ortho-dichlorobenzene and anisole can be particularly mentioned.

The polyetherimides (1) are generally prepared at a temperature of at least 110° C., specifically 150° C. to 275° C., more specifically 175° C. to 225° C. for solution polymerization. For melt polymerization, the temperature can be from 250° C. to 350° C. At temperatures below 110° C., reaction rates may be too slow for economical operation. Atmospheric or super-atmospheric pressures can be used, for example up to 5 atmospheres, to facilitate the use of high temperatures without causing solvent to be lost by evaporation.

The reacting of the dianhydride (3) and the organic diamine (4) to form polyetherimide (1) is generally conducted for about 0.5 to about 30 hours, specifically about 1 to about 20 hours. Advantageously, the reaction is complete 20 hours or less.

The solvent, diamine (4) and dianhydride (3) can be combined in amounts such that the total solids content during the reaction to form polyetherimide (1) are 5 weight percent (wt %) to 70 wt %, specifically 10 wt % to 70 wt %, more specifically 20 wt % to 70 wt %. “Total solids content” expresses the proportion of the reactants as a percentage of the total weight including liquids present in the reaction at any given time. It may be desirable to have low water content in the reaction mixture. Thus, in some embodiments, the combined dianhydride, organic diamine, the catalyst and the solvent, if present, (reaction mixture) may comprise less than or equal to 200 parts per million parts of the combined components weight (ppm) of water, more specifically, less than or equal to 100 ppm of water, still more specifically, less than or equal to 50 ppm of water, or, yet more specifically, less than or equal to 25 ppm of water, based on the combined weight of dianhydride (3), organic diamine (4), the optional catalyst and the solvent, if present. In some embodiments, the reaction mixture comprises less than or equal to 100 ppm water. In other embodiments, water is removed in boiling solvents and the reaction mixture can comprise less than 5 wt % to 1 ppm of water depending on the reaction conditions and the point of the reaction.

A molar ratio of dianhydride (3) to diamine (4) of 0.9:1 to 1.1:1, more specifically about 1:1 can be used. While other ratios may be employed, a slight excess of dianhydride or diamine may be desirable. A proper stoichiometric balance between dianhydride (3) and diamine (4) is maintained to prevent undesirable by-products that can limit the molecular weight of the polymer, and/or result in polymers with amine end groups. Accordingly, in an embodiment, imidization proceeds adding diamine (4) to a mixture of dianhydride (3) and solvent to form a reaction mixture having a targeted initial molar ratio of dianhydride to diamine; heating the reaction mixture to a temperature of at least 100° C. (optionally in the presence of an imidization catalyst); analyzing the molar ratio of the heated reaction mixture to determine the actual initial molar ratio of dianhydride (3) to diamine (4); and, if necessary, adding dianhydride (3) or diamine (4) to the analyzed reaction mixture to adjust the molar ratio of dianhydride (3) to diamine (4) to 0.9:1 to 1.5:1.

In some embodiments, the polycondensation is conducted in the presence of an endcapping agent such as a monoanhydride (or a dicarboxylic acid analogue) or monoamine, or a combination comprising at least one of the foregoing. Exemplary dicarboxylic anhydride endcapping agents include phthalic anhydride, 2,3-benzophenonedicarboxylic anhydride, 3,4-benzophenonedicarboxylic anhydride, 2,3-dicarboxyphenylphenyl ether anhydride, 2,3-biphenyldicarboxylic anhydride, 3,4-biphenyldicarboxylic anhydride, 2,3-dicarboxyphenylphenyl sulfone anhydride, 3,4-dicarboxyphenylphenyl sulfone anhydride, 2,3-dicarboxyphenylphenyl sulfide anhydride, 1,2-naphthalenedicarboxylic anhydride, 2,3-naphthalenedicarboxylic anhydride, 1,8-naphthalenedicarboxylic anhydride, 1,2-anthracenedicarboxylic anhydride, 2,3-anthracenedicarboxylic anhydride and 1,9-anthracenedicarboxylic anhydride. These monoanhydrides may have a group unreactive to the amine or the dicarboxylic anhydride in the molecule. Examples of the monoamines include aniline, o-toluidine, m-toluidine, p-toluidine, 2,3-xylidine, 2,4-xylidine, 2,5-xylidine, 2,6-xylidine, 3,4-xylidine, 3,5-xylidine, o-chloroaniline, m-chloroaniline, p-chloroaniline, o-nitroaniline, o-bromoaniline, m-bromoaniline, m-nitroaniline, p-nitroaniline, o-aminophenol, m-aminophenol, p-aminophenol, o-anilidine, m-anilidine, p-anilidine, o-phenetidine, m-phenetidine, p-phenetidine, o-aminobenzaldehyde, m-aminobenzaldehyde, p-aminobenzaldehyde, o-aminobenzonitrile, m-aminobenzonitrile, p-aminobenzonitrile, 2-aminobiphenyl, 3-aminobiphenyl, 4-aminobiphenyl, 2-aminophenolphenyl ether, 3-aminophenolphenyl ether, 4-aminophenolphenyl ether, 2-aminobenzophenone, 3-aminobenzophenone, 4-aminobenzophenone, 2-aminophenolphenyl sulfide, 3-aminophenolphenyl sulfide, 4-aminophenolphenyl sulfide, 2-aminophenolphenyl sulfone, 3-aminophenolphenyl sulfone, 4-aminophenolphenyl sulfone, α-naphthylamine, β-naphthylamine, 1-amino-2-naphthol, 2-amino-1-naphthol, 4-amino-1-naphthol, 5-amino-1-naphthol, 5-amino-2-naphthol, 6-amino-1-naphthol, 7-amino-2-naphthol, 8-amino-2-naphthol, 1-aminoanthracene, 2-aminoanthracene and 9-aminoanthracene. These monoamines may have a group unreactive to the amine or the dicarboxylic anhydride in the molecule.

If the endcapping agent is an amine, the amount of the endcapping agent added to the reaction mixture can be in the range of about 0-10 mole percent of the total amount of anhydride monomer. If, on the other hand, the endcapping agent is an anhydride, then the amount of the endcapping agent added to the reaction mixture can be in the range of about 0-10 mole percent of the amount of the amine monomer. The endcapping agent can be added at any e.g., to the diamine (4), the dianhydride (3), or a combination thereof, before or after the polycondensation reaction has started. In some embodiments, the endcapping agents are mixed with or dissolved into reactants having the similar functionality. For example. monoamine endcapping agents can be mixed with or dissolved into diamines, and monoanhydride can be mixed with or dissolved into dianhydrides.

Polycondensation of dianhydride (3) and organic diamine (4) (imidization) may conducted in the presence of a catalyst. Exemplary catalysts include sodium aryl phosphinates, guanidinium salts, pyridinium salts, imidazolium salts, tetra(C₇₋₂₄ arylalkylene) ammonium salts, dialkyl heterocycloaliphatic ammonium salts, bis-alkyl quaternary ammonium salts, (C₇₋₂₄ arylalkylene)(C₁₋₁₆ alkyl) phosphonium salts, (C₆₋₂₄ aryl)(C₁₋₁₆ alkyl) phosphonium salts, phosphazenium salts, and combinations thereof.

The foregoing salts include an anionic component, which is not particularly limited. Examples of anions include chloride, bromide, iodide, sulfate, phosphate, acetate, maculate, tosylate, and the like. A combination of different anions can be used. Salts are frequently referred to by the identity of the anion and as such the guanidinium, pyridinium or imidazolium salt may be a halide salt, nitrate salt, nitrite salt, boron-containing salt, antimony-containing salt, phosphate salt, carbonate salt, carboxylate salt or a combination of two or more of the foregoing.

A catalytically active amount of the catalyst can be determined by one of skill in the art without undue experimentation, and can be, for example, more than 0 to 5 mole percent, specifically 0.01 to 2 mole percent, and more specifically 0.1 to 1.5 mole percent, and still more specifically 0.2 to 1.0 mole percent based on the moles of organic diamine (8).

The catalyst can be added any time during the polycondensation reaction between the dianhydride and the organic diamine. For example, the catalyst can be added at the beginning of the reaction, at the end of the reaction, or anytime during the reaction. The catalyst can also be added continuously or in portions during the course of the reaction. In some embodiments, an amount of catalyst effective to catalyze the polycondensation of the dianhydride and the organic diamine can be added at the beginning of the reaction, for example about 0.2 mole %, based on the moles of the organic diamine, and an additional amount can be added at any time during the polycondensation reaction.

Completion of the polycondensation reaction can be defined as the time after which no further increase in weight average molecular weight of the polyetherimide is observed. Advantageously, when the catalyst of this disclosure is utilized, the polycondensation reaction is complete in less than 30 hours, specifically less than 25 hours, more specifically less than 20 hours, and still more specifically less than 10 hours. In certain embodiments, the reaction mixture is taken to as high of Mw as possible in a set time, for example, 3 to 6 hours and the rest of the reaction is finished during devolitization of solvent in an apparatus like a wiped film evaporator or a devolatizing extruder.

The polyetherimides produced as described herein have reduced levels of the cyclic n=1 byproduct shown in formula (7)

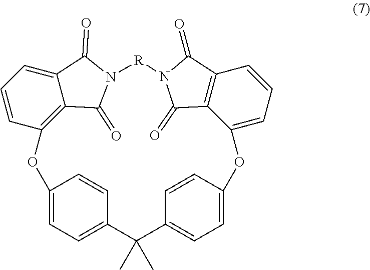

In an embodiment, the polyetherimide manufactured as described above comprises, based on the weight of the polyetherimide, less than or equal to 1 wt %, specifically less than or equal to 0.75 wt %, more specifically less than or equal to 0.5 wt % of the cyclic n=1 adduct. As discussed above, the extremely low level of cyclic byproduct is surprising since the ether-forming polymerization process is known to produce significant amounts of cyclic byproduct yet the analogous regioisomers in the polycondensation process produce less than 1 weight percent, based on the total weight of the polyetherimide.

The compositions can further optionally comprise a reinforcing filler, for example a flat, plate-like, and/or fibrous filler. Exemplary reinforcing fillers of this type include glass flakes, mica, flaked silicon carbide, aluminum diboride, aluminum flakes, and steel flakes; wollastonite comprising surface-treated wollastonite; calcium carbonate comprising chalk, limestone, marble and synthetic, precipitated calcium carbonates, generally in the form of a ground particulates; talc, comprising fibrous, modular, needle shaped, and lamellar talc; kaolin, comprising hard, soft, calcined kaolin, and kaolin comprising various coatings known in the art to facilitate compatibility with the polymeric matrix resin; mica; and feldspar.

Exemplary reinforcing fillers also include fibrous fillers such as short inorganic fibers, natural mineral fibrous fillers, single crystal fibers, glass fibers, ceramic fibers, and organic reinforcing fibrous fillers. Short inorganic fibers include, borosilicate glass, carbon fibers, and those derived from blends comprising at least one of aluminum silicates, aluminum oxides, magnesium oxides, and calcium sulfate hemihydrate. Single crystal fibers or “whiskers” include silicon carbide, alumina, boron carbide, iron, nickel, and copper single crystal fibers. Glass fibers, comprising glass fibers such as E, ECR, S, and NE glasses and quartz, and the like can also be used.

In some applications it can be desirable to treat the surface of the filler with a chemical coupling agent to improve adhesion to a thermoplastic resin in the composition. Examples of useful coupling agents are alkoxy silanes and alkoxy zirconates. Amino, epoxy, amide, or thio functional alkoxy silanes are especially useful. Fiber coatings with high thermal stability are preferred to prevent decomposition of the coating, which could result in foaming or gas generation during processing at the high melt temperatures required to form the compositions into molded parts.

The polyetherimide compositions can include various additives ordinarily incorporated into polymer compositions of this type, with the proviso that any additive is selected so as to not significantly adversely affect the desired properties of the composition. Exemplary additives include antioxidants, thermal stabilizers, light stabilizers, ultraviolet light (UV) absorbing additives, quenchers, plasticizers, lubricants, mold release agents, antistatic agents, visual effect additives such as dyes, pigments, and light effect additives, flame resistances, anti-drip agents, and radiation stabilizers. Combinations of additives can be used. The foregoing additives (except any fillers) are generally present in an amount from 0.005 to 20 wt. %, specifically 0.01 to 10 wt. %, based on the total weight of the composition.

In some instances it is desired to have polyetherimide compositions that are essentially free of bromine and chlorine. “Essentially free” of bromine and chlorine means that the composition has less than 3 wt. % of bromine and chlorine, and in other embodiments less than 1 wt. % bromine and chlorine by weight of the composition. In other embodiments, the composition is halogen free. “Halogen free” is defined as having a halogen content (total amount of fluorine, bromine, chlorine and iodine) of less than or equal to 1000 parts by weight of halogen per million parts by weight of the total composition (ppm). The amount of halogen can be determined by ordinary chemical analysis such as atomic absorption.

The polyetherimide compositions can be prepared by blending the ingredients under conditions for the formation of an intimate blend. Such conditions often include melt mixing in single or twin screw type extruders, mixing bowl, or similar mixing devices that can apply a shear to the components. Twin-screw extruders are often preferred due to their more intensive mixing capability and self-wiping capability, over single screw extruders. It is often advantageous to apply a vacuum to the blend through at least one vent port in the extruder to remove volatile impurities in the composition. Often it is advantageous to dry the polyetherimide polymers prior to melting. The melt processing is often done at 290 to 370° C. to avoid excessive polymer degradation while still allowing sufficient melting to get an intimate polymer mixture free of any unbelted components. The polymer blend can also be melt filtered using a 40 to 100 micrometer candle or screen filter to remove undesirable black specks or other heterogeneous contaminants.

In an exemplary process, the various components are placed into an extrusion compounder to produce a continuous strand that is cooled and then chopped into pellets. In another procedure, the components are mixed by dry blending, and then fluxed on a mill and comminuted, or extruded and chopped. The composition and any optional components can also be mixed and directly molded, e.g., by injection or transfer molding techniques. Preferably, all of the components are freed from as much water as possible. In addition, compounding is carried out to ensure that the residence time in the machine is short; the temperature is carefully controlled; the friction heat is utilized; and an intimate blend between the components is obtained.

The composition can then be molded in any equipment conventionally used for thermoplastic compositions, such as a Newbury or van Dorn type injection-molding machine with conventional cylinder temperatures, at 320° C. to 420° C., and conventional mold temperatures at 100° C. to 170° C.

The polyetherimide compositions can be formed into articles by any number of methods, for example, shaping, extruding (including profile extrusion), thermoforming, or molding, including injection molding, compression molding, gas assist molding, structural foam molding, and blow molding. In one embodiment a method of forming an article comprises shaping, extruding, blow molding, or injection molding the composition to form the article. Polyetherimide compositions can also formed into articles using thermoplastic processes such as film and sheet extrusion, for example melt casting, blown film extrusion and calendaring. Co-extrusion and lamination processes can be used to form composite multi-layer films or sheets.

Examples of applications include: food service, medical, lighting, lenses, sight glasses, windows, enclosures, safety shields, and the like. The high melt flow allows the composition to be molded into intricate parts with complex shapes and/or thin sections and long flow lengths. Examples of other articles include, but are not limited to, cookware, medical devices, trays, plates, handles, helmets, animal cages, electrical connectors, enclosures for electrical equipment, engine parts, automotive engine parts, lighting sockets and reflectors, electric motor parts, power distribution equipment, communication equipment, computers and the like, comprising devices that have molded in snap fit connectors. The polyetherimide compositions can also be made into film and sheet as well as compositions of laminate systems. Other articles include, for example, fibers, sheets, films, multilayer sheets, multilayer films, molded parts, extruded profiles, coated parts and foams: windows, luggage racks, wall panels, chair parts, lighting panels, diffusers, shades, partitions, lenses, skylights, lighting devices, reflectors, ductwork, cable trays, conduits, pipes, cable ties, wire coatings, electrical connectors, air handling devices, ventilators, louvers, insulation, bins, storage containers, doors, hinges, handles, sinks, mirror housing, mirrors, toilet seats, hangers, coat hooks, shelving, ladders, hand rails, steps, carts, trays, cookware, food service equipment, communications equipment and instrument panels.

The compositions are especially useful for articles such as reflectors, e.g., automobile reflectors, an optical lens, a fiber optic connector, and an adhesive.

Without further elaboration, it is believed that one skilled in the art can, using the description herein, utilize the present invention. The following examples are included to provide additional guidance to those skilled in the art of practicing the claims. Accordingly, these examples are not intended to limit the invention in any manner.

### EXAMPLES

Materials used in the Examples are listed Table 1. Amounts listed in the Examples are in weight percent (wt. %), based on the total weight of the composition.

TABLE 1

| Material | Chemical Description | Source |
|---|---|---|
| mPD | Meta-phenylene diamine | DuPont |
| 4,4′-ODA | 4,4′-oxydianiline | SigmaAldrich |
| PA | phthalic anhydride | Koppers |
| 3-CIPA | 3-chlorophthalic anhydride | SABIC |
| 4,4′-BPADA | 4,4′-bisphenol A dianhydride | SABIC |
| 3,3′-BPADA | 3,3′-bisphenol A dianhydride | SABIC |

### Gel Permeation Chromatograph (GPC) Testing Procedure

The GPC samples were prepared by dissolving 5-10 milligrams (mg) of a sample in 10 mL of dichloromethane. Three to five drops of the polymer solution was added to a 10 milliliters (mL) dichloromethane solution with acetic acid (1-2 drops). The sample solution was then filtered and the analysis was performed by referencing the polymer peak to the oDCB peak. The instrument was a Waters 2695 separations module, which was calibrated with polystyrene standards from Aldrich chemical company. The cyclics [n=1] were analyzed by forcing a drop line on the baseline followed by integration.

### Differential Scanning Calorimetry (DSC)

The DSC measurements on the polymer grinds obtained via Haake devolatilization were performed with a TA Q1000 DSC instrument. The glass transition temperature (Tg) was measured on a 10 mg polymer sample (solid) at a heating rate of 20° C./min. The sample was scanned from 40-300° C. under nitrogen atmosphere and the second heat temperature was reported.

### Rheology Testing Procedure

The viscosity data was measured on polymer grinds using parallel plate rheometry, at 380° C. The frequency sweep comparison at lower frequency (1 rad/sec to 316 rad/sec) as well as the viscosity decrease (apparent viscosity decrease) over injection molding shear rates was determined. The ratio of viscosities at 1 rad/s to 100 rad/sec was measured at 380° C. This viscosity ratio gives a measure of shear thinning or improved flow properties. The higher the viscosity ratio, the higher is the shear thinning and hence improved flow.

The polymers prepared were targeted for 55,000 Mw, (polystyrene standards were used for calibration), but some were slightly higher and lower Mw. The polydispersity index (PDI) of the 3-C1PA enriched polymers were higher than the comparative example because of the cyclic [n=1] concentration. The cyclic [n=1] is an adduct from the reaction of one mole equivalent of bisphenol A dianhydride and and one mole equivalent of diamine; and is characteristic of only the 3,3′-bisphenol A enriched polymer systems due to the higher concentration of 3,3′-bisphenol A dianhydride.

### Polymerization

A 500 mL, three-necked flask equipped with a stopper and a gas valve were charged with 3,3′-BPADA, 4,4′-BPADA, phthalic anhydride (PA), metaphenylene diamine (mPD), and ortho-dichlorobenzene. The molar amounts of 3,3′-BPADA, 4,4′-BPADA are shown in Table 2. The flask was then equipped with a stir shaft and bearing, nitrogen adapter, and a Dean Stark trap receiver topped with a reflux condenser. A gentle sweep of nitrogen was established through the headspace of the vessel. The reaction was then heated to 100° C., and then ramped slowly to 180° C. The oDCB was removed from the mixture until it reached 35-40 wt % solids (20 grams approximately of oDCB). The mixture is heated at 180° C. and sampled every hour to measure Mw. The Mw analysis was continued until targeted Mw molecular weight was achieved by GPC (plateau: 3 samples within 300 atomic mass units if the Mw was below 45,000 a correction of either dianhydride or diamine was made). The reaction was then cooled and devolatilized at 380° C. to obtain polymer blobs, which upon grinding were used for analysis and testing. Results are shown in Table 2.

TABLE 2

| | | | | | | Comparative |
|---|---|---|---|---|---|---|
| | Ex. 1 | Ex. 2 | Ex. 3 | Ex. 4 | Ex. 5 | Ex. 1 |
| 4,4′-BPADA | 2 | 15 | 25 | 35 | 50 | 100 |
| (mol %) | | | | | | |
| 3,3′-BPADA | 98 | 85 | 75 | 65 | 50 | 0 |
| (mol %) | | | | | | |
| mPD | 100 | 100 | 100 | 100 | 100 | 100 |
| (mol %) | | | | | | |
| Properties | | | | | | |
| Mw | 57443 | 63050 | 59534 | 55309 | 57878 | 53495 |
| Mn | 16284 | 19187 | 18928 | 18914 | 21277 | 24734 |
| PDI | 3.46 | 3.29 | 3.11 | 2.86 | 2.70 | 2.18 |
| Cyclics | 0.58 | 0.45 | 0.41 | 0.27 | 0.18 | Not |
| (n = 1) wt % | | | | | | applicable |
| Tg ° C. | 221 | 222 | 219 | 220 | 213 | 218 |
| Rheology ratio | 2.52 | 1.78 | 1.76 | 2.32 | 1.60 | 1.48 |

The purpose of Examples 1-5 was to evaluate the effect of increasing levels 4,4′-BPADA on the heat performance, flow, and cyclics [n=1] concentration. The 3,3′-BPADA levels varied from 98 mol % to 50 mol %. It is very interesting to note that the cyclics concentration remained less than 0.5 wt % even at highest loading of 3,3′-BPADA. The polymers prepared were targeted for a weight average molecular weight of 55,000 atomic mass unit (amu) (polystyrene standards were used for calibration). As can be seen from Table 2, the PDI of the 3,3′-BPADA enriched polymer were slightly higher than comparative example 1 as cyclics [n=1] byproduct were slightly increased. Also, the cyclic levels found to be between 0.18 to 0.58 wt %. The data also suggested that concentration of 3,3′-BPADA does have strong influence on the cyclics levels. However, it is interesting to notice that cyclic [n=1] levels remained well below 1 wt %. For comparison, the cyclic [n=1] level of a PEI made by the ether-forming polymerization process using 98 mol % 3-chlorophthalic anhydride, 2 mol % 4-chlorophthalic anhydride and metaphenylenediamine was 15 wt %. Structurally, this comparative PEI is analogous to Example 1.

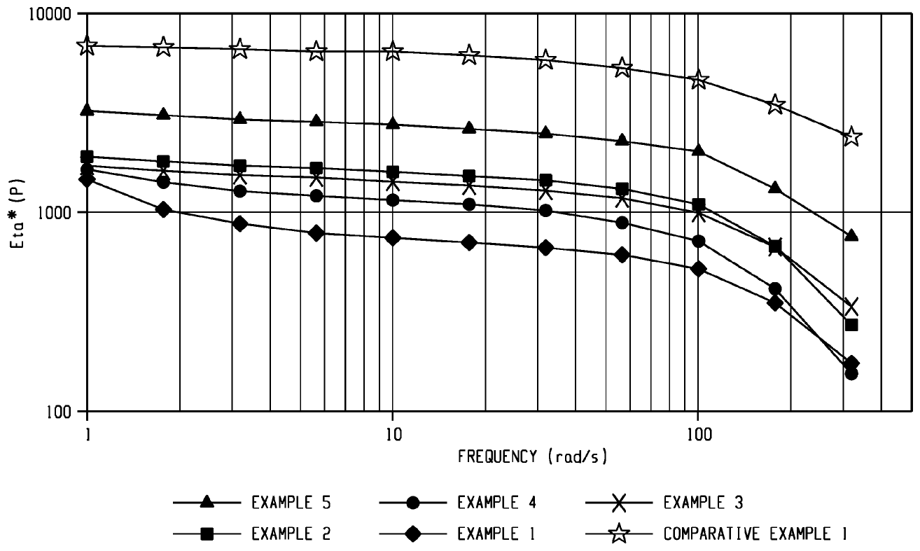

The PEI of examples 1-5 had Tg up to 222° C. The viscosity measurements of the polymer samples were performed using Parallel Plate Rheometry at 380° C. The frequency sweep comparison of these 3-BPADA enriched PEI's with Comparative example 16 at 380° C. showed that the PEI example 1-5 have lower viscosity than a control sample at lower frequency. The examples 1-5 had a rheology ratio (flow) of 1.6-2.5, whereas the PEI of comparative example 16, made from using 100 mol % of 4,4′-BPADA had a rheology ratio of 1.5. FIG. 1 shows lower shear viscosity behavior of 3-BPADA enriched PEIs in comparison to Comparative Example 1.

Further samples were made with a different diamine, 4,4′-oxydianiline. In 4,4′-oxydianiline, there are ten bonds between diamine groups. The polymerization process proceeded in a similar manner to examples 1-5, except m-phenylene diamine was replaced with an equivalent molar amount of 4,4′-oxydianiline. The Mw analysis was continued until targeted Mw molecular weight was achieved by GPC (plateau: 3 samples within 300 atomic mass units if the Mw was below 30,000 g/mol a correction of either dianhydride or diamine was made).

TABLE 3

| | | | | Comparative |
|---|---|---|---|---|
| | Ex. 6 | Ex. 7 | Ex. 8 | Ex. 2 |
| 4,4′-BPADA (mol %) | 2 | 25 | 50 | 100 |
| 3,3′-BPADA (mol %) | 98 | 75 | 50 | 0 |
| 4,4′-ODA (mol %) | 100 | 100 | 100 | 100 |
| Properties | | | | |
| Mw | 37755 | 36887 | 37201 | 41527 |
| Mn | 16135 | 15900 | 16316 | 18134 |
| PDI | 2.34 | 2.32 | 2.28 | 2.29 |
| Cyclics (n = 1) wt % | 0.36 | 0.44 | 0.27 | 0.35 |
| Tg ° C. | 231 | 227 | 223 | 217 |

In this set of examples, the cyclic concentration remained less than 0.5 wt % at all concentrations of 4,4′-BPADA and 3,3′-BPADA. The PEI of Examples 6-8 has Tg of greater than 223° C.

This disclosure further encompasses the following embodiments.

Embodiment 1. A method of making a polyetherimide comprising reacting a diamine having four bonds or more between the amine groups, 3,3′-bisphenol A dianhydride, and 4,4′-bisphenol A dianhydride to form a polyetherimide having a cyclics content less than 1 weight percent (wt %), a glass transition temperature greater than or equal to 213° C., and a weight average molecular weight greater than or equal to 25,000 Daltons, wherein the molar ratio of 3,3′-bisphenol A dianhydride to 4,4′-bisphenol A dianhydride is 98:02 to 10:90.

Embodiment 2. A method of making a polyetherimide comprising reacting a diamine having 4 to 10 bonds between the amine groups, 3,3′-bisphenol A dianhydride, and 4,4′-bisphenol A dianhydride to form a polyetherimide having a cyclics content less than 1 wt % based on the total weight of the polyetherimide, a glass transition temperature greater than or equal to 213° C., and a weight average molecular weight greater than or equal to 25,000 Daltons, wherein the molar ratio of 3,3′-bisphenol A dianhydride to 4,4′-bisphenol A dianhydride is 98:02 to 10:90.

Embodiment 3. A method of making a polyetherimide comprising reacting metaphenylenediamine or 4,4′-diaminodiphenyl ether, 3,3′-bisphenol A dianhydride, 4,4′-bisphenol A dianhydride and phthalic anhydride in a solvent to form a polyetherimide having a cyclics content less than 1 wt % based on the total weight of the polyetherimide, a glass transition temperature greater than or equal to 213° C., and a weight average molecular weight greater than or equal to 25,000 Daltons, wherein the molar ratio of 3,3′-bisphenol A dianhydride to 4,4′-bisphenol A dianhydride is 98:02 to 10:90.

Embodiment 4. The method of Embodiment 1, wherein the diamine having four or more bonds between the amine groups is present in an amount greater than or equal to 50 mol %, or, greater than or equal to 75 mol %, or, greater than or equal to 95 mol %, based on the total number of moles of diamine.

Embodiment 5. The method of Embodiment 2, wherein the diamine having 4 to 10 bonds between the amine groups is present in an amount greater than or equal to 50 mol %, or, greater than or equal to 75 mol %, or, greater than or equal to 95 mol %, based on the total number of moles of diamine.

Embodiment 6. The method of Embodiment 3, wherein the metaphenylenediamine or 4,4′-diaminodiphenyl ether is present in an amount greater than or equal to 50 mol %, or, greater than or equal to 75 mol %, or, greater than or equal to 95 mol %, based on the total number of moles of diamine.

Embodiment 7. The method of any of the preceding Embodiments, wherein the produced polyetherimide has a viscosity that is at least 25% lower than the viscosity of a polyetherimide produced using 100 mol % 4,4′-bisphenol A dianhydride.

Embodiment 8. The method of any of the preceding Embodiments wherein the mixture further comprises a solvent.

Embodiment 9. The method of Embodiment 8, wherein the solvent comprises o-dichlorobenzene, dichlorotoluene, 1,2,4-trichlorobenzene, diphenyl sulfone, anisole, veratrole, diphenylether, or phenetole, sulfolane, dimethyl sulfone, dimethyl formamide, dimethyl acetamide, N-methylpyrrolidone, dimethyl sulfoxide, m-cresol, hexamethyl phosphoramide, dimethyl imidazole, or a combination thereof.

Embodiment 10. The method of any of the preceding Embodiments, wherein reacting occurs in the presence of a catalyst.

Embodiment 11. The method of Embodiment 10, wherein the catalyst comprises a sodium aryl phosphinate, guanidinium salt, pyridinium salt, imidazolium salt, tetra(C₇₋₂₄ arylalkylene) ammonium salt, dialkyl heterocycloaliphatic ammonium salt, bis-alkyl quaternary ammonium salt, (C₇₋₂₄ arylalkylene)(C₁₋₁₆ alkyl) phosphonium salt, (C₆₋₂₄ aryl)(C₁₋₁₆ alkyl) phosphonium salt, phosphazenium salt, or a combination thereof.

Embodiment 12. The method of any of Embodiments 8 to 11, wherein the total solids content is 5 wt % to 70 wt %.

Embodiment 13. The method of any of the preceding Embodiments wherein the mixture further comprises an endcapping agent.

Embodiment 14. The method of Embodiment 13, wherein the endcapping agent comprises a monoamine, monoanhydride, or a combination comprising at least one of the foregoing.

Embodiment 15. The method of Embodiment 13, wherein the endcapping agent comprises phthalic anhydride.

Embodiment 16. The method of any of the preceding Embodiments wherein the cyclics content is less than 0.5 wt %.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group.

As used herein, the term “hydrocarbyl” includes groups containing carbon, hydrogen, and optionally one or more heteroatoms (e.g., 1, 2, 3, or 4 atoms such as halogen, O, N, S, P, or Si). “Alkyl” means a branched or straight chain, saturated, monovalent hydrocarbon group, e.g., methyl, ethyl, i-propyl, and n-butyl. “Alkylene” means a straight or branched chain, saturated, divalent hydrocarbon group (e.g., methylene (—CH2-) or propylene (—(CH2)3-)). “Alkenyl” and “alkenylene” mean a monovalent or divalent, respectively, straight or branched chain hydrocarbon group having at least one carbon-carbon double bond (e.g., ethenyl (—HC═CH2) or propenylene (—HC(CH3)=CH2-). “Alkynyl” means a straight or branched chain, monovalent hydrocarbon group having at least one carbon-carbon triple bond (e.g., ethynyl). “Alkoxy” means an alkyl group linked via an oxygen (i.e., alkyl-O—), for example methoxy, ethoxy, and sec-butyloxy. “Cycloalkyl” and “cycloalkylene” mean a monovalent and divalent cyclic hydrocarbon group, respectively, of the formula -CnH2n-x and -CnH2n-2x- wherein x is the number of cyclization(s). “Aryl” means a monovalent, monocyclic or polycyclic aromatic group (e.g., phenyl or naphthyl). “Arylene” means a divalent, monocyclic or polycyclic aromatic group (e.g., phenylene or naphthylene). “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more halogen (F, Cl, Br, or I) substituents, which can be the same or different. The prefix “hetero” means a group or compound that includes at least one ring member that is a heteroatom (e.g., 1, 2, or 3 heteroatoms, wherein each heteroatom is independently N, O, S, or P.

“Substituted” means that the compound or group is substituted with at least one (e.g., 1, 2, 3, or 4) substituents instead of hydrogen, where each substituent is independently nitro (—NO2), cyano (—CN), hydroxy (—OH), halogen, thiol (—SH), thiocyano (—SCN), C1-6 alkyl, C2-6 alkenyl, C2-6 alkynyl, C1-6 haloalkyl, C1-9 alkoxy, C1-6 haloalkoxy, C3-12 cycloalkyl, C5-18 cycloalkenyl, C6-12 aryl, C7-13 arylalkylene (e.g, benzyl), C7-12 alkylarylene (e.g, toluyl), C4-12 heterocycloalkyl, C3-12 heteroaryl, C1-6 alkyl sulfonyl (—S(═O)2-alkyl), C6-12 arylsulfonyl (—S(═O)2-aryl), or tosyl (CH3C6H4SO2-), provided that the substituted atom's normal valence is not exceeded, and that the substitution does not significantly adversely affect the manufacture, stability, or desired property of the compound. When a compound is substituted, the indicated number of carbon atoms is the total number of carbon atoms in the group, including those of the substituent(s).

All patents and references cited herein are incorporated by reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method of making a polyetherimide comprising reacting a diamine having four bonds or more between the amine groups, 3,3′-bisphenol A dianhydride, and 4,4′-bisphenol A dianhydride to form a polyetherimide having a cyclics content less than 1 weight percent (wt %), a glass transition temperature greater than or equal to 213° C., and a weight average molecular weight greater than or equal to 25,000 Daltons, wherein the molar ratio of 3,3′-bisphenol A dianhydride to 4,4′-bisphenol A dianhydride is 98:02 to 10:90.

2. The method of claim 1, wherein the diamine having four bonds or more between the amine has 4 to 10 bonds between the amine groups.

3. The method of claim 1, wherein the diamine having four bonds or more between the amine groups comprises metaphenylenediamine.

4. The method of claim 1, wherein the diamine having four or more bonds between the amine groups is present in an amount greater than or equal to 50 mol %, or, greater than or equal to 75 mol %, or, greater than or equal to 95 mol %, based on the total number of moles of diamine

5. The method of claim 2, wherein the diamine having 4 to 10 bonds between the amine groups is present in an amount greater than or equal to 50 mol %, or, greater than or equal to 75 mol %, or, greater than or equal to 95 mol %, based on the total number of moles of diamine.

6. The method of claim 3, wherein the metaphenylenediamine is present in an amount greater than or equal to 50 mol %, or, greater than or equal to 75 mol %, or, greater than or equal to 95 mol %, based on the total number of moles of diamine.

7. The method of claim 1, wherein the produced polyetherimide has a viscosity that is at least 25% lower than the viscosity of a polyetherimide produced using 100 mol % 4,4′-bisphenol A dianhydride.

8. The method of claim 1, wherein the mixture further comprises a solvent.

9. The method of claim 8, wherein the solvent comprises o-dichlorobenzene, dichlorotoluene, 1,2,4-trichlorobenzene, diphenyl sulfone, anisole, veratrole, diphenylether, or phenetole, sulfolane, dimethyl sulfone, dimethyl formamide, dimethyl acetamide, N-methylpyrrolidone, dimethyl sulfoxide, m-cresol, hexamethyl phosphoramide, dimethyl imidazole, or a combination thereof.

10. The method of claim 1, wherein reacting occurs in the presence of a catalyst.

11. The method of claim 10, wherein the catalyst comprises a sodium aryl phosphinate, guanidinium salt, pyridinium salt, imidazolium salt, tetra(C₇₋₂₄ arylalkylene) ammonium salt, dialkyl heterocycloaliphatic ammonium salt, bis-alkyl quaternary ammonium salt, (C₇₋₂₄ arylalkylene)(C₁₋₁₆ alkyl) phosphonium salt, (C₆₋₂₄ aryl)(C₁₋₁₆ alkyl) phosphonium salt, phosphazenium salt, or a combination thereof.

12. The method of claim 8, wherein the total solids content is 5 wt % to 70 wt %.

13. The method of claim 1, wherein the mixture further comprises an endcapping agent.

14. The method of claim 13, wherein the endcapping agent comprises a monoamine, monoanhydride, or a combination comprising at least one of the foregoing.

15. The method of claim 13, wherein the endcapping agent comprises phthalic anhydride.

16. The method of claim 1 wherein the cyclics content is less than 0.5 wt %.

17. A method of making a polyetherimide comprising reacting a diamine having 4 to 10 bonds between the amine groups, 3,3′-bisphenol A dianhydride, and 4,4′-bisphenol A dianhydride to form a polyetherimide having a cyclics content less than 0.5 wt % based on the total weight of the polyetherimide, a glass transition temperature greater than or equal to 213° C., and a weight average molecular weight greater than or equal to 25,000 Daltons, wherein the molar ratio of 3,3′-bisphenol A dianhydride to 4,4′-bisphenol A dianhydride is 98:02 to 10:90.

18. A method of making a polyetherimide comprising reacting metaphenylenediamine, 3,3′-bisphenol A dianhydride, 4,4′-bisphenol A dianhydride and phthalic anhydride in a solvent to form a polyetherimide having a cyclics content less than 0.5 wt % based on the total weight of the polyetherimide, a glass transition temperature greater than or equal to 213° C., and a weight average molecular weight greater than or equal to 25,000 Daltons, wherein the molar ratio of 3,3′-bisphenol A dianhydride to 4,4′-bisphenol A dianhydride is 98:02 to 10:90.
